(19) United States
(12) Patent Application Publication
(10) Pub. No.: US 2001/0049003 A1
(43) Pub. Date: Dec. 6, 2001

(54) DECORATIVE STONE

(76) Inventors: ERNST MICHAEL WINTER, HAMBURG (DE); LOTHAR SCHAFER, ABBESBUTTEL (DE); THORSTEN MATTHEE, MEINE (DE)

Correspondence Address: ROBERT W BECKER & ASSOCIATES, 11896 N HIGHWAY 14 SUITE B, TIJERAS, NM, 87059

(21) Appl. No.: 09/319,142

(22) PCT Filed: Sep. 23, 1998
(86) PCT No.: PCT/EP98/06074

§ 371 Date: None

(30) Foreign Application Priority Data
Sep. 30, 1997 (DE) 297 17 496.7

(51) Int. Cl. B32B 3/30

(52) U.S. Cl. 428/156

(57) ABSTRACT

A gemstone has a plate-shaped support having a surface with at least one pyramid-shaped depression. A precious stone layer is produced by vapor phase deposition on the plate-shaped support. The precious stone layer can be cut.

The invention relates to artificial gemstones.

Gemstones, especially precious stones, are cut or polished before they are mounted in the metal body of a piece of jewelry in order to provide spectral diffraction of the incident light and to reflect the incident light, thus resulting in the brilliance and fire of the gemstone. However, this requires a minimal size and purity of the gemstone. For example, two thirds of the mined diamonds are not suitable for producing gemstones by cutting because they are either too small, have not the required height, or because of their color or inclusions can only be used for industrial (technical) purposes.

The brilliance, respectively, the luster of the diamond results from the portion of the incident light impinging on the gemstone being reflected in the direction where the light is coming from. This is achieved in that the light which impinges through the upper facets into the diamond crystal is reflected at the lower brilliant area and exits through the upper facets. The light is thus reflected in at least two reflection steps by a total of approximately (180°±x°). The arrangement of the facet angle relative to one another must take into consideration the optical properties of the boundary surface diamond/air so that the angle of total reflection is never surpassed.

It is important in the context of the beam path within the diamond that at the back facets, i.e., at the lower portion of the diamond, the angle of the light beam path is always greater than the angle of total reflection. This means that the light is reflected back upwardly, while it must impinge on the upper facets and the table with such an angle that the light can exit. Diamond brilliants are not cut such that the light is reflected exactly in the direction in which it impinges on it, as is the case for reflectors instead, between the incident and the exiting light beam an open angle is provided which results in reflection that will impinge on the eye. The exit angle is different due to the dispersion for different wavelengths.

An important feature for the fire of the brilliant is the dispersion of light within the diamond which results in that the light is diffracted as it is in a prism and is then perceived by the eye as spectral colors.

Further effects which occur when viewing a brilliant are the many reflections which come from the facets and impinge on the eye when the brilliant is turned. These are the essential objectives that must be fulfilled by the facets.

Artificial diamond layers which are produced by CVD processes are either too expensive or too thin to produce therefrom cut gemstones, for example, brilliants, which can provide the impressive luster that determines their value. Important for the luster is the adherence to a precise geometric shape in order to reflect a portion of the incident light as large as possible into the impinging light direction.

It is an object of the invention to provide artificial gemstones from precious stone layers produced by vapor phase deposition on large surface areas which, despite the unfavorable dimensions, i.e., the limited thickness of such layers, provide an attractive appearance.

This object is inventively solved with a gemstone which is comprised of a preferably plate-shaped support or substrate having one surface that is provided with at least one pyramid-shaped depression and which supports a precious stone layer that is produced by vapor phase deposition, preferably according to the CVD or PVD methods.

In order for the precious stone layer, especially diamond layer, of the inventive gemstone to have the required brilliance, its underside that is resting on a support, for example, a silicone wafer, must be embodied such that, as in the case of the single crystal natural brilliance, it will produce a reflection of most of the incident light. This can be achieved by a respective pre-treatment of the surface of the silicon wafer to be coated. According to this pre-treatment, the silicon wafer has the required shape as a negative matrix so that the backside or underside of the diamond layer to be formed will have the respective positive shape. As a support or base for such artificially produced diamond layers, silicon wafers are especially suitable but also such materials as precious metals, tungsten, molybdenum, or hard metals which can be coated easily with diamond and at whose surface a structure as required can be produced.

Producing the structure in the support to be coated can be achieved, as a function of its material, by mechanical means, i.e., cutting a certain profile, by electrolytic means or, especially in the case of silicon wafers, by chemical or plasma-technological means by etching. It is possible to employ isotropic as well as anisotropic methods. As an anisotropic etching medium, KOH can be used. This base results in the formation of pyramid-shaped etching depressions in a single-crystalline wafer. When employing an etching mask, it is also possible to produce by an isotropic etching medium a pyramid-shaped structure in a support. A suitable composition of the etching solution can produce the required angles of the pyramid. If as mentioned above, a stepwise reflection by approximately 180°±x° is desired, the angles of the pyramid must be adapted accordingly.

The edge area of the support of the gemstone layer can be provided with other pyramid angles than the center portion. However, it is also possible to provide the reflecting surfaces (facets) at the underside of the layer with different angles. In this manner, the brilliance and the fire can be adjusted independent from one another. The angles of the facets can be selected such that the light in the gemstone layer is reflected multiple times so that a great diffraction of the spectral colors can be achieved.

It is easiest to provide with a single etching action on the entire surface of the support the same angle, having, for example, a pyramid opening angle of 109°. This angle can be achieved easily by etching processes. Before etching is carried out, the surface of the support can be subjected to a laser action in order to provide the desired geometry.

It is also possible to use wafers having other orientations than (100) or (111). Important in this context is the directed cooperation of the crystal orientation of the precious stone layer and the direction of the etching action in order to provide an optimal optical effect. In a polycrystalline artificial diamond layer, for example, produced by a CVD method, in contrast to a single crystal diamond crystal grain boundaries are present which must be taken into consideration as additional refracting areas having a different refractive index. This has the consequence that the grain boundaries advantageously must be aligned with respect to their structure, for example, in a column-like arrangement, in order to provide a positive effect on brilliance and fire. In any case, the effect of the grain boundary must be taken into consideration for the optical effect.

In a simple pyramid shape the light can also be refracted by providing a mirror layer on the backside or underside of the vapor phase precious stone, especially a CVD diamond, in the form of gold or titanium layer. Then, the reflection will result from reflective action at the gold or titanium surface acting as a mirror.

In order to approximate as closely as possible the brilliance and the fire of single crystal brilliants, an octahedron shape of the surface of the artificial diamond layer is advantageous which can be cut subsequently to its production. The angles at the underside must be matched to the changed exit ratios.

These carriers, having a precious stone layer produced by vapor phase deposition, can be used as gemstones in the conventional manner, for example, can be mounted on a metal body of a piece of jewelry.

The surface of the support or substrate carrying the deposited precious stone layer must not be planar. For example, it can be convex in order to provide artificial gemstones in the shape of a cabochon or button.

The invention provides for manufacture of artificial gemstones, especially diamonds, not only with special optical properties such as brilliance and fire, but also with surface dimensions, for example, by multi dimensioning, that cannot be achieved even in approximation with natural stones and also not with other synthetic methods, especially not the high pressure/high temperature technology for economical and technical reasons. The inventive gemstone can be provided with its own colors employing a gas phase of a respective composition, for example, it is possible to provide a blue color by boron, or a yellow color by nitrogen, so that the inventive gemstones can be used for any suitable piece of jewelry or any suitable decoration purpose with precious stones.

One embodiment of the inventive gemstone will be explained with the aid of the drawings.

It is shown in:

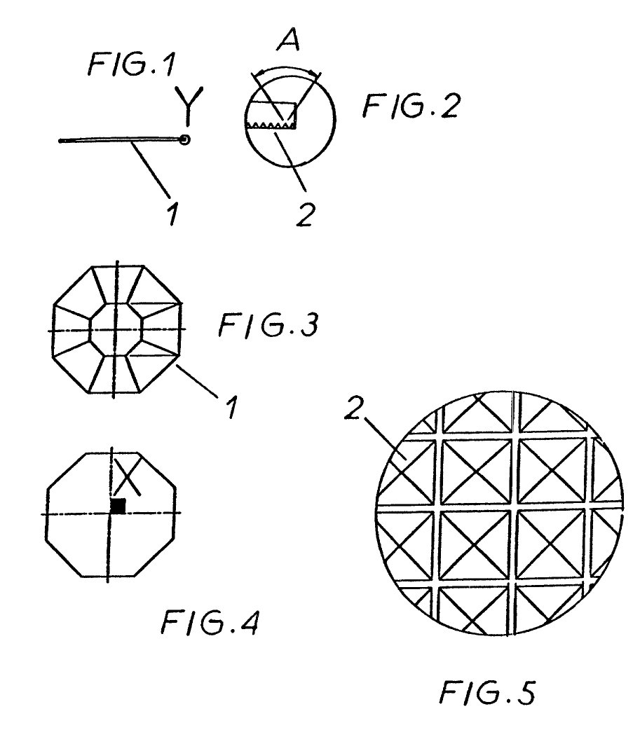

FIG. 1 a schematic side view of the precious stone layer of a gemstone;

FIG. 2 a schematic view of the area Y of FIG. 1 in an enlarged representation;

FIG. 3 a schematic plan view onto the precious stone layer of FIG. 1;

FIG. 4 a schematic view of the precious stone layer according to FIG. 1 from below;

FIG. 5 a schematic view of the area X of FIG. 4 in an enlarged representation.

For reasons of simplification and clarity, only the precious stone layer 1 is shown in the drawings without the support, whereby the support has a side which is mirror-symmetrically formed relative to the precious stone layer 1.

The precious stone layer 1 has at its underside a plurality of pyramid-shaped projections 2 having an angle “A”, while its upperside is provided with an octahedron facet cut.

The precious stone layer 1, which is fixedly adhered to the non-represented support and is cut, thus provides the inventive gemstone which can be mounted in a piece of jewelry, for example, a ring.

The support onto which the precious stone layer is to be applied must not have the dimensions of the gemstone to be produced. When a large-surface area support is used and provided with a precious stone layer, parts can be cut therefrom and then processed to a gemstone.

1. Gemstone, characterized by a preferably plate-shaped support having a surface with at least one pyramid-shaped depression and supporting a precious stone layer (1) produced by gas phase deposition.

2. Gemstone according to claim 1, characterized in that the support is silicon wafer.

3. Gemstone according to claim 2, characterized in that the support is a wafer of (100) or (111) orientation.

4. Gemstone according to claim 1, characterized in that the support is comprised of a precious metal.

5. Gemstone according to claim 1, characterized in that the support is comprised of hard metal.

6. Gemstone according to claim 1, characterized in that the support is comprised of a refractive metal such as tungsten or molybdenum.

7. Gemstone according to one of the claims 1 through 6, characterized in that the pyramid-shaped depressions are produced by mechanical, for example, cutting or stamping, means.

8. Gemstone according to one of the claims 1 through 6, characterized in that the pyramid-shaped depressions are produced by etching.

9. Gemstone according to one of the preceding claims, characterized in that the pyramid angle of the depressions within a support may differ.

10. Gemstone according to one of the preceding claims, characterized in that the pyramid angle of the depressions is approximately 109°.

11. Gemstone, according to one of the preceding claims, characterized in that the grain boundaries of the precious stone layer (1) are aligned in a column shape.

12. Gemstone according to one of the preceding claims, characterized in that the pyramid-shaped depressions have a mirror surface.

13. Gemstone according to one of the preceding claims, characterized in that the surface of the precious stone layer (1) is cut.

14. Gemstone according to one of the preceding claims, characterized in that the gemstone layer (1) has its, own color produced by doping.

15. Gemstone according to one of the proceeding claims, characterized in that the surface of the support supporting the precious stone layer (1) is curved.
